(19) United States
(12) Patent Application Publication
(10) Pub. No.: US 2026/0007149 A1
(43) Pub. Date: Jan. 8, 2026

(54) EXTRUDED PRODUCT AND A PROCESS FOR MAKING THE SAME

(71) Applicant: Oatly AB, MALMÖ (SE)

(72) Inventors: Sofia Ehlde, MALMÖ (SE); Karin Petersson, MALMÖ (SE)

(21) Appl. No.: 18/881,686

(22) PCT Filed: Jul. 7, 2022
(86) PCT No.: PCT/EP2022/068908

§ 371 Date: Jan. 6, 2025

(51) Int. Cl. A23J 3/26; A23J 3/14; A23J 3/22; A23P 30/20

(52) U.S. Cl. CPC A23J 3/26; A23J 3/14; A23J 3/227; A23P 30/20

(57) ABSTRACT

A process for manufacturing of an extruded food product, including: extruding, under heating, of an extrusion mixture comprising an oat derived composition comprising oat protein and dietary fiber, one or more additional vegetable protein fractions, and water, whereby an extruded food product is formed. Further disclosed is an extruded product.

### TECHNICAL FIELD OF INVENTION

The present invention relates to process for manufacturing of an extruded food product, and to an extruded food product.

### BACKGROUND

Nutritious products having low impact on the environment and climate and which have an all-vegetable origin are desirable and sought by consumers. Further, there exists a growing interest and demand for vegetarian and vegan meat substitute products, such as vegetarian meat substitute products resembling poultry or beef. It is desirable, but challenging, that such products are nutritious as well as having properties, such as structure and organoleptic properties, resembling a meat product. Vegan alternatives are further challenging to manufacture, since vegetable proteins often are associated with flavours not associated with meat, or being difficult to process into products resembling meat.

There is a further interest in, and need for, minimising waste from the food industry, and particularly waste of nutritional material usable for food production. Such material often is disposed of as feed or for energy production. It would be desirable and beneficial, eg. when attempting to lower the environmental impact from a food industry, to find alternative uses of material normally viewed as less useful by-products in food manufacturing.

### SUMMARY OF INVENTION

It is a purpose of the present invention to address or solve at least one problem or need of prior art. It is a further purpose to provide a process for manufacturing of an extruded food product, and to an extruded food product. It is a yet further purpose to provide an extruded food product directly usable for consumption after heating or cooking.

According to a first aspect of the present inventive concept there is provided a process for manufacturing of an extruded food product. The process comprises extruding, under heating, of an extrusion mixture comprising: an oat derived composition comprising oat protein and dietary fibre; one or more additional vegetable protein fractions; and water; whereby an extruded food product is formed.

With such an oat derived composition and one or more vegetable protein fractions and water, extrusion may be efficiently be performed and a resulting extruded food product may be provided with desirable properties, including, for example, having a fibrous structure suitable for meat substitutes. Further, the food product can be provided with high nutritious values in combination with being vegetarian or vegan.

According to a second aspect of the present inventive concept there is provided an extruded food product obtainable by the method according to the first aspect.

According to a third aspect of the present inventive concept, there is provided an extruded food product comprising an oat derived composition comprising oat protein and dietary fibre; one or more additional vegetable protein fraction; and water.

### BRIEF DESCRIPTION OF THE DRAWINGS

Aspects of the present disclosure will now be described in more detail, with reference to the appended drawings showing embodiments of the invention, in which:

FIG. 1 schematically illustrates a process for manufacturing of an extruded food product.

FIG. 2 illustrates light microscopy pictures of slices of extruded food product.

FIGS. 3(a) and 3(b) illustrate extruded food product drawn from photographs.

FIGS. 4(a) to (g) illustrates extruded food products drawn from photographs.

FIGS. 5(a) to (c) illustrates extruded food products drawn from photographs.

FIG. 6 illustrates photos obtained of extruded products as drawn in FIGS. 3(a) and 3(b).

FIG. 7 illustrates photos obtained of extruded products as drawn in FIGS. 4(a) to (g).

FIG. 8 illustrates photos obtained of extruded products as drawn in FIGS. 5(a) to (c).

### DETAILED DESCRIPTION

The present invention will now be described more fully hereinafter. This invention may, however, be embodied in many different forms and should not be construed as limited to the embodiments set forth herein; rather, these embodiments are provided for thoroughness and completeness, and for fully convey the scope of the invention to a skilled person. Although individual features may be included in different embodiments, these may possibly be combined in other ways, and the inclusion in different embodiments does not imply that a combination of features is not feasible. In addition, singular references do not exclude a plurality. In the context of the present invention, the terms “a”, “an” does not preclude a plurality.

The present inventive concepts are, at least in part, based on unexpected realisations that nutritious extruded food products having several desirable properties may be manufactured from extrusion mixtures comprising oat derived composition and vegetable protein. Further, ways have been discovered allowing the oat derived composition of the extruded food products to be manufactured without unnecessary waste material being produced as by-product, for example manufactured while at the same time a useful liquid oat product is obtained, essentially without other by-products. The, thus obtained, liquid oat product may be used for providing an oat drink. Thereby, the oat derived composition for the extruded oat product may be provided or manufactured without, or with minimum, waste of edible material. The manufacturing of the extruded food product, for example, a meat substitute product, may, thus, make desirable use of by-products from oat drink production.

“Oat derived”, as used herein, refers to that the (oat derived) composition at least to a major part, preferably entirely, may be derived from, obtained from or manufactured from oats material. For example, the oats material may be oat kernels, or part of oat kernels. Oat derived composition may, thus and for example, refer to a composition produced from micronized oat kernels wherein the manufacturing may comprise modifications to components of the oats material, such as, for example, treatment by enzymes, whereby components originally present in the oats material may be transformed and/or removed, such as degraded starch.

Protein fractions as use herein refers to a vegetable protein product obtained from a plant source, such as eg. chickpea or pea, and being rich in protein from that source. Although the protein fractions may essentially or entirely consist of proteins from the plant source, thus a highly or entirely purified protein fraction is not excluded, it may also comprise other components from that plant source in addition to the protein, from that plant source. For example, protein concentrate and protein isolate, shall be considered to comprise at least 50%, such as at least 56%, or 50-60%, of protein by weight of the additional vegetable protein fraction, the remainder being components other than the protein. Such additional vegetable protein fractions may typically be more readily available as compared to a more purified source of protein.

Herein, amounts of water in extrusion mixtures is sometimes provided or exemplified using water by weight of the wet extrusion mixture or the extruded food product. It shall be realised that for a case where the extruded food product consists of, or are manufactured from, the extrusion mixture, which comprises water, without other water being added the process and/or essentially without any of the water of the extrusion mixture being removed during the process, the water content of the extrusion mixture and the extruded food product may essentially be identical.

The water content of the extruded food product may be same as, or similar to, the water content of the extrusion mixture.

If no dry matter other than dry matter of the extrusion mixture is added or removed from the process, the amount of components of the extrusion mixture expressed as dry weight of the extrusion mixture, may be same as the amount of components of the extrusion mixture expressed as dry weight of the extruded food product.

Water present in the extrusion mixture may, for example, be separated from the extrusion mixture during or after extrusion, thereby, the water content of the extrusion mixture may vary from the water content of the extruded food product.

According to a first aspect of the present inventive concept there is provided a process for manufacturing of an extruded food product. The process comprises extruding, under heating, of an extrusion mixture comprising: an oat derived composition comprising oat protein and dietary fibre; one or more additional vegetable protein fractions; and water; whereby an extruded food product is formed.

With such an oat derived composition and one or more vegetable protein fractions and water, extrusion may be efficiently performed and a resulting extruded food product may be provided with desirable properties, including, for example, having a fibrous structure. Further, the food product can be provided with high nutritious values in combination with being vegetarian or vegan. A high protein content of the extruded product is typically obtained from a combination of oat derived material and the additional vegetable protein fraction, and the product further benefits from high content of dietary fibres.

The extruding under heating may be referred to as extrusion cooking.

The extruded food product may be an extruded product used as food or a component in food, directly or after further treatment and/or cooking, or an extruded product used in manufacturing of a food product.

The extruded food product may be a food product used as, or used for manufacturing of, a meat analogue product or a meat substitute product, for example substituting poultry, such as chicken meat. Extrusion mixtures according to embodiments provides for fibrous structures of the extruded products which may be regarded as resembling meat structure.

The oat derived composition may comprise, by dry weight of the oat derived composition, 20-55% of oat protein, and 20-40% of dietary fibre.

Such oat derived composition provides amounts of both fibre and proteins which are suitable for the extrusion, and allows provision of desirable nutritious food products. Further, such an oat derived composition provides vegetable protein in addition to the additional vegetable protein fractions.

The one or more additional vegetable protein fractions may be selected from the group consisting of pea protein fraction, and chickpea protein fraction. Such protein fractions may provide the food product with suitable nutritious values, and together with other components of the food product allows that a mixture efficiently can be extruded.

The process for manufacturing of an extruded food product may further comprise: mixing of the oat derived composition and the one or more additional vegetable protein fractions before or during the extruding under heating; and adding water.

It shall be understood that the mixing of the oat derived composition and the one or more additional vegetable protein fractions, may be conducted before adding the oat derived composition and the one or more additional vegetable protein fractions to an extruder. According to an example a mixer may be provided upstream, or before, the extruder. According to another example, the oat derived composition and the one or more additional vegetable protein fractions may be provided pre-mixed to the extruder.

Alternatively, the oat derived composition and the one or more additional vegetable protein fractions may be mixed inside the extruder. For example, the oat derived composition and the one or more additional vegetable protein fractions may be fed the extruder in separate streams and contacted and mixed after being fed to the extruder. The oat derived composition and the one or more additional vegetable protein fractions may also be partially mixed before being fed to the extruder, in which extruder the mixing is proceeded.

Where or when the mixing is conducted may depend on the type of extruder, some extruders are constructed to facilitate mixing inside the extruder, while some extruders are constructed to receive a mixture and not primarily result in mixing inside of the extruder, although the mixing may be proceeding within the extruder.

Thus, the process for manufacturing of an extruded food product may comprise a variety of suitable means for mixing, while still providing extruded food products comprising a mixture of oat derived composition and the one or more additional vegetable protein fractions.

The adding water may be conducted before or during the extruding under heating, such as during mixing of the oat derived composition and the one or more additional vegetable proteins before or during the extruding as described herein above concerning mixing of the oat derived composition and the one or more additional vegetable protein fractions.

Although ingredients may be mixed before being presented to an extruder, the mixing may typically be conducted inside the extruder, or during extrusion.

The one or more additional vegetable protein fractions may comprise chickpea protein. The one or more additional vegetable protein fractions may consist only of chickpea protein fraction.

Thereby, it has been shown that an extrusion mixture having suitable properties for extrusion can be realized, and a food product with desirable organoleptic properties can be achieved, as well as having suitable flavour profile. Further, use of chickpea protein contributes to allowing higher levels of oat derived composition to be incorporated in the extrusion mixture, for example as compared to use of pea protein alone, thus allowing improved nutritious values. This is believed to, at least in part, be a result of a protein network obtained with the chickpea proteins within the extrusion mixture. Increasing levels of oat derived material further is beneficial from environmental perspectives, eg. by making use of by-products from oat drink manufacturing. Benefits with a content of chickpea protein in the extrusion mixture is also realised when chickpea protein is mixed with other vegetable proteins, such as pea protein.

When the one or more vegetable protein fractions comprise chickpea protein, the one or more additional vegetable protein fraction may further comprise pea protein.

The one or more additional vegetable protein fractions may consist only of chickpea protein fraction and pea protein fraction.

Thereby, it has been shown that an extrusion mixture having suitable properties for extrusion can be realized, and a food product with desirable organoleptic properties can be achieved.

Each of the one or more vegetable protein fractions may, independently, be selected from vegetable protein fractions having a protein content, by weight of the fraction, of at least 95%, protein isolate having a protein content of at least 80%, or a protein concentrate having a protein content of at least 50%. In particular, protein isolate having a protein content of at least 80%, or a protein concentrate having a protein content of at least 50% may be used with the process.

Thereby, it shall be realised that although it is possible to use highly concentrated protein fractions, such as having protein content of above 95%, or even 100%, it is efficient to use protein fractions having lower concentrations of protein, such as above 50%. Protein fractions having such lower concentrations of protein may be more readily available, less processed, and suitable for use in the extrusion.

The oat derived composition may further comprise, by dry weight of the composition, 5-20% of fat, and 3-20% of carbohydrates.

Thus, the oat derived composition may in addition to other ingredients of the extrusion mixture, including additional vegetable protein fraction, provide the food product with oat protein, fibre, fat and carbohydrates. Such components have desirable effects on both the extruded food product and the process of extrusion. For example, fat contributes to provision of a desirable extrusion process.

3-20%, such as 5-15%, by dry weight of the oat derived composition, may be sugars. A major portion of the sugars, or above 50% of total sugars, may be maltose. For example, 5 to 15%, by dry weight of the oat derived composition, may be maltose. Herein, if sugars are present in the oat derived composition, the sugars are considered to be part of the carbohydrates.

Components or compounds from the oat derived composition, including for example, oat protein, fibre, fat and carbohydrates are obtained from oats, such as by enzymatic treatment of oats, such as oat kernels, optionally combined with fractionation or separation of thus treated oats.

The oat derived composition may be obtained or manufactured, as a side or residual product from manufacturing of oat drink or what is sometimes referred to as an oat milk. Use of the, thus obtained, oat derived composition may in addition to be of high nutritional value and be used in food production as described herein, also be of value for reducing or avoiding waste from manufacturing of oat drink. The method for manufacturing the oat derived composition may comprise treating an aqueous oat slurry or suspension with amylase or other starch degrading enzyme, and may further comprise separating a fibre depleted slurry in form of oat drink, while providng the oat derived composition in form of a fibre rich slurry. It has been realized that a side stream product from manufacturing of oat drink may provide excellent dietary properties in combination with being suitable for use as in food or feed production. The oat derived composition may be obtained as a by-product from manufacturing of oat drink.

As such, the oat derived composition may comprise, by dry weight of the oat derived composition: 20-55% of oat protein; 5-20% of fat; 20-40% of dietary fibre; and 3-20% of carbohydrates.

The oat derived composition may to a major part by dry weight of the composition be in form of particles.

2-9% by dry weight of the oat derived composition, may be β-glucan. If β-glucans are present in the oat derived composition, the β-glucans are considered to be part of the dietary fibre.

3-20%, or 5-15%, by dry weight of the oat derived composition, may be sugars.

The oat derived composition may further comprise, by dry weight of the composition, 0-15%, such as 2-10% of ash.

The water content of the oat derived composition may be 1-20% by weight of the oat derived composition, or 5-15%, or 5-10%. Alternatively, the oat derived composition may have a water content of the oat derived composition being 60-80% by weight of the oat derived composition.

50% or more, such as 60% or more, or 90% or more, by weight of the sugar of the oat derived composition may be maltose.

The extrusion mixture may comprise, by dry weight of the extrusion mixture: 20-45% of the oat derived composition; and 55-80% of the one or more additional vegetable protein fractions. In particular, the extrusion mixture may comprise, by dry weight of the extrusion mixture: 20-40%, such as 30-40%, of the oat derived composition; and 60-80%, such as 60-70% of the one or more additional vegetable protein fractions.

Such composition of the extrusion mixture provides properties of the mixture particular suitable for extrusion and lends the food product desirable properties with regard to, for example, structure and nutritious composition.

As described herein above, the one or more additional vegetable protein fractions may entirely consist of protein, or for example comprise 50-60% by weight of protein. The extrusion mixture, when comprising 55-80% by weight of the one or more additional vegetable protein fractions, may comprise 22.5-80% by weight of additional vegetable protein.

The above content of the extrusion mixture, of oat derived composition and additional vegetable protein fraction, are expressed per dry weight of the composition. The extrusion mixture, as explained, further comprises water. The content of water in the extrusion mixture may be 45-85% by weight of the extruded food product, or of the extrusion mixture. In particular, the content of water in the extrusion mixture may be 55-75% by weight of the extruded food product, or of the extrusion mixture.

The extrusion mixture may further comprise additional additives or ingredients such as selected from eg. vegetable fat, flavourings and salt. For example, 1-10% by weight may be edible oil.

Thus, the extrusion mixture may comprise: an oat derived composition comprising oat protein and dietary fibre; one or more additional vegetable protein fractions; additives; and water; wherein the additives may be selected as one or more of salt, vegetable fat, such as vegetable oil, and optionally other additives. Optional other additives may be different additives suitable for foods and food productions, such as, for example, starch, sugars, minerals, fibres and vitamins. The additives and other additives may be added in a total amount of, for example, 1-10% by weight of the extrusion mixture. The additives and other additives may be of types that can be described as non-dairy, vegan, vegetarian, and/or vegetable. Additives may alternatively or in addition be added to the extruded product after the extrusion.

The process for manufacturing of an extruded food product, may be a process for manufacturing of an extruded food product comprising: extruding, under heating, of an extrusion mixture having a total protein content, including oat protein from the oat derived composition and the one or more additional vegetable protein fractions of at least 31.5% by dry weight of the extrusion mixture. The amount of protein, obtained from calculations taking into account the oat derived composition comprising, by dry weight of the composition, at least 20% protein, may be contributed to by the oat derived material as well as the additional vegetable protein. In accordance with examples and embodiments herein, the amount of protein in the extruded product may be in par with or be higher than, for example, chicken meat or beef.

The extruding may be performed by means of a single screw extruder or a double screw extruder, wherein the heating involves increasing the temperature of the extrusion mixture within the temperature range 25 to 160° C.

The single screw extruder or the double screw extruder may comprise a cooling nozzle arranged to cool the extrusion mixture from the heating down to below 40° C., such as 20-30° C.

According to a second aspect of the present inventive concept there is provided an extruded food product obtainable by the method according to the first aspect.

Herein mentioned features of the first aspect and the third aspect, when applicable, apply to this second aspect as well. In order to avoid undue repetition, reference is made to the first aspect and the third aspect.

According to a third aspect of the present inventive concept, there is provided an extruded food product comprising an oat derived composition comprising oat protein and dietary fibre; one or more additional vegetable protein fraction; and water.

The oat derived composition may comprise, by dry weight of the composition, 20-55% of oat protein, and 20-40% of dietary fibre; and the one or more additional vegetable protein fractions may be selected from the group consisting of pea protein fraction, and chickpea protein fraction.

Such extruded food products may have desirable fibrous texture, suitable for use as meat analogues.

The one or more additional vegetable protein fractions may comprise chickpea protein.

If the one or more additional vegetable protein fractions comprises chickpea protein, the one or more additional vegetable protein fractions may further comprises pea protein.

Each of the one or more vegetable protein fractions may independently be selected from vegetable protein fractions having a protein content of at least 95%, protein isolate having a protein content of at least 80%, or a protein concentrate having a protein content of at least 50%, for example a protein content within the range of 50-100%.

If the oat derived composition comprises, by dry weight of the composition, 20-55% of oat protein, and 20-40% of dietary fibre; and the one or more additional vegetable protein fractions are selected from the group consisting of pea protein fraction, and chickpea protein fraction, the oat derived composition may further comprise, by dry weight of the composition, 5-20% of fat, and 3-20% of carbohydrates.

The extruded food product may comprise, by dry weight of the extruded food product, 20-45% of the oat derived composition; and 55-80% of the one or more additional vegetable protein fractions.

Above mentioned features of the first aspect and the second aspect, when applicable, apply to this third aspect as well. In order to avoid undue repetition, reference is made to the above.

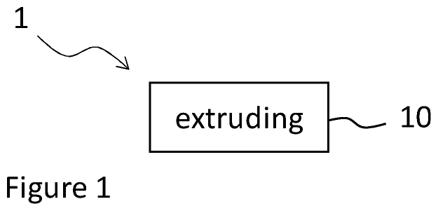

With reference to FIG. 1, a process for manufacturing of an extruded food product will now be described. The process 1 comprises extruding 10, under heating, of an extrusion mixture comprising: an oat derived composition comprising oat protein and dietary fibre; one or more additional vegetable protein fractions; and water; whereby an extruded food product is formed.

It shall be understood that the process 1 further may comprise mixing of the oat derived composition and the one or more additional vegetable protein fractions before or during the extruding 10 under heating, or before or during entry to the extruder; and adding water.

The mixing may be conducted or realized by means of an extruder used for the extrusion.

Preceding the mixing, the process may comprise providing the oat derived composition comprising oat protein and dietary fibre; and the one or more additional vegetable protein fractions.

The adding water may be conducted before or during the extruding under heating; or part of the water may be added before the extruding under heating and part of the water may be added during the extruding under heating. Such as during mixing of the oat derived composition and the one or more additional vegetable proteins before or during the extruding. Although ingredients may be mixed before being presented to an extruder, the mixing may be conducted inside the extruder or during extrusion.

### Experiments and Examples

Experiments were conducted with different compositions of the extrusion mixture with an aim of providing meat analogues/substitutes. A purpose of the experiments was to provide extruded food products suitable for use as or use in production of meat analogues.

For the experiments, oat derived compositions described as comprising the following content within the following intervals were used, expressed as dry weight of the composition: 20-55% of oat protein, 5-20% of fat, 20-40% of dietary fibre, and 3-20% of carbohydrates, all components of the oat derived composition were inherent to oats and obtained from an oats source. As such, the oat derived composition was obtained as a side stream from oat drink manufacturing using amylase for degrading starch and providing a liquid water rich fibre depleted phase rich in carbohydrates, used for oat drink manufacturing, and a water depleted fibre rich slurry separated from the water depleted phase and comprising the oat derived composition. The water depleted fibre rich slurry separated from the water rich phase was dried to a powderous structure having a moisture content of below 15%, or 5-15%. It shall be appreciated that also higher moisture levels also are suitable for the oat derived composition for extrusion mixtures, but may not have as long shelf life. More precisely, the oat derived compositions for the experiments were analysed to comprise the following, by dry weight of the oat derived composition: 32-39%, or about 30-40%, of protein; 31-35%, or about 30-40%, of dietary fibres; 4-6%, or about 0-10%, of β-glucan; 14-15%, or about 10-20%, of fat; 7-14%, or about 5-20% of carbohydrates, including sugars, i.e. within herein above disclosed intervals.

Additional vegetable protein fractions selected for experiments are listed in table 1. The additional vegetable protein fractions are commercially available and used as obtained from provider. In addition, an other vegetable protein isolate (OVPI) was also included as additional vegetable protein fraction and used in some of the experiments. The OVPI is a vegetable protein isolate obtained from seeds from a crop other than chickpea, pea, or oats having a protein content of 90%.

TABLE 1
Additional vegetable protein fractions. Proteincontent expressed
in % by weight of the additional vegetable protein fraction.

| Name | Type | Protein content |
|---|---|---|
| CPI | Chickpea protein isolate | 70% protein |
| PPC | Pea protein concentrate | 56% protein |
| PPI | Pea protein isolate | 80% protein |

### Characterisation of Extruded Product

Samples obtained from extrusion were freeze sliced using Leica cryostat and studied directly under light microscopy, undied or died using iodine, light green and/or OsO4 for clarifying protein, starch, fibre and fat.

### Texture

Warner-Bratzler, or cutting resistance, were conducted on extruded products in two directions followed by calculation of a ratio between a force necessary to cut across fibres and a force necessary to cut along fibres. A ratio above 1 indicates a fibrous structure and above 1.5 is considered to correspond to particularly desirable fibrous structure of the extruded products particularly suitable for use as meat substitute.

### Mixing Chamber

A mixing chamber was used for pre-experiments to estimate processability of materials for following extrusion experiments. Parameters such as temperature, holding timesand rotation speed are controllable. A Brabender mixing chamber was used.

Additional vegetable protein fractions CPI, PPI, OVPI and PPC were investigated seperately together with oat derived composition (0-60% by weight) and water levels within the range 54-73% by weight. Rotation speed and holding times were varied.

### Single Screw Extrusion

Compositions were selected for extrusion compositions from mixing chamber experiments and investigated using a single screw extruder (Teach-Line E20T extruder (Dr Collin GmbH, Germany)). The extruder has four heating zones and an extra heating element for the nozzle. The following heating profile was used: zone 1—30° C., zone 2—80° C., zone 3—120° C., zone 4—140° C. and zone 5—50° C. Zone 1 corresponds to a feeding section and zone 5 to the nozzle. A compression screw (2:1) and a circular nozzle having a 3 mm diameter was used. Materials were fed to the extruder manually. The speed was around 75 rpm. Compositions used with the single screw extruder are presented in table 2.

TABLE 2
Extrusion mixtures for single screw extruder. Amounts
of protein fraction and of oat derived composition per
dry weight of the extrusion mixture, and water by weight
of the wet extrusion mixture/extruded product

| | Water | Protein fraction | Oat derived composition |
|---|---|---|---|
| PPC | 35% | 52% | 48% |
| PPC | 35% | 60% | 40% |
| PPI | 60% | 71.5% | 28.6% |
| PPI | 50% | 50% | 50% |
| CPI | 54% | 71.5% | 28.5% |
| CPI | 54% | 80.7% | 19.3% |

### Results Single Screw Extrusion

Results from single screw extrusion were considered promising concerning experiments with chickpea protein fraction and oat derived composition, which provided desirable potential, for example concerning fibrous structure resembling fibrous meat structures. PPC appeard least promising, which was believed to be at least in part due to the relative high levels of oat derived composition for the experiments.

From the experiments it was further concluded that suitable levels of oat derived composition in the extrusion mixture may be around 30%.

### Double Screw Extrusion

Compositions were selected for extrusion compositions from mixing chamber experiments and investigated using double screw extruder (a co-rotating KSE 20/40 extruder (Brabender, Germany)). The extruder has four heating zones and a thermo element in connection with the nozzle. Speed and temperatures were varied in zones 3-5, but were maintained constant at 40° C. in zone 1 and 80° C. or 90° C. in zone 2. A cooling nozzle was used having dimensions of 8×30*300 mm, which was set to cool the extruded product to about 25° C. when leaving the nozzle, for structuring present proteins into fibrous structures.

It was a purpose of the experiments to maximise contents of oat derived compositions (varied in experiments between 0-50% by dry weight of the extrusion mixture). Further desirable would be a high water content such as around 60-70% by weight of the extrusion mixture.

Zone 1 corresponds to a feeding section and zone 5 to the nozzle. A compression screw (2:1) and a circular nozzle having a 3 mm diameter was used. Materials were fed to the extruder manually.

The experiments included several extrusion mixtures with different ratios between CPI and PPI, CPI and OVPI, and CPI, PPI and OVPI, with varying levels of oat derived composition.

### Results Double Screw Extrusion

It was noted and concluded from experiments that, for example, extrusion mixtures comprising, by dry weight of the mixture, 30-40% oat derived composition, and 60-70% additional vegetable protein fraction comprising chick pea protein or both chickpea protein and pea protein, such as in form of CPI, or CPI and PPI, performed very well. In particular, a water content in the extrusion mixture of 60-70%, or around 65% was found possible and suitable. Also lower water levels are possible, which results in dryer products. Temperature profiles of for example around 40/80/130/150/130 proved useful. Meat-like fibrous structures were obtained.

From experiments it was realised that chickpea protein, alone or in combination, as compared to pea protein alone allows a higher level of oat derived composition to be mixed in with the extrusion mixture. This was found to be an effect of a strong protein network formed within the extrusion mixture and the extruded food product when chickpea protein was used. Thereby, the method and extruded food products of embodiments allows that material which may be a side stream or by-product from oat drink manufacturing may be used in high amounts in manufacturing of meat substitute products.

It was further found that the inclusion of chickpea protein, alone or in combination, provided beneficial flavour profile, with less contribution to flavour from the vegetable protein.

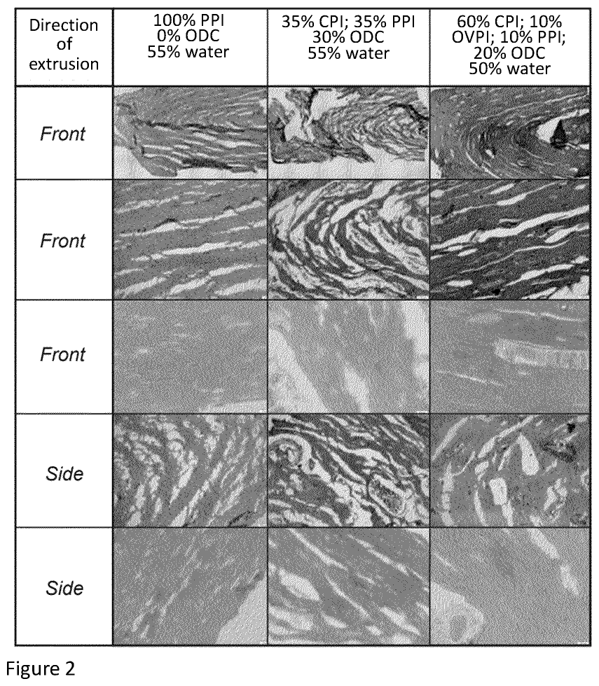

Light microscopy analysis indicated desirable fibrous structures to samples. FIG. 2 illustrates light microscopy picture for extruded food products obtained from extrusion mixtures having different contents of PPI, CPI/PPI and CPI/OVPI/PPI (given as % by dry weight of the extrusion mixture in FIG. 2), and different contents of oat derived composition (ODC, given as % by dry weight of the extrusion mixture in FIG. 2). Pictures in a column in FIG. 2 are obtained at different amplifications and contains both front views and side views of the samples in relation to direction of extrusion as indicated in FIG. 2. The extrusion mixtures comprising oat derived composition, as compared to the sample without oat derived composition (0% ODC in FIG. 2), had a more porous structure, contributing to a texture with improved mouth feel when consumed.

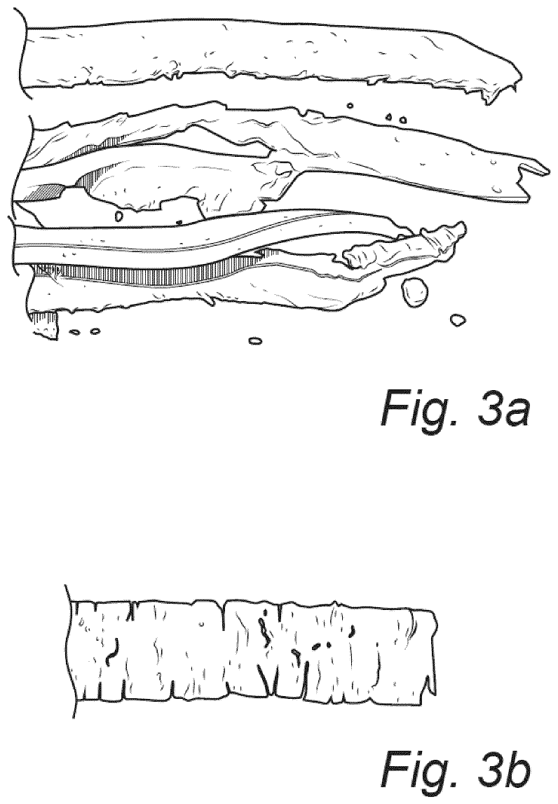

Experiments with PPI, and with CPI, without oat derived composition, were extruded and results are given in FIG. 3(a) (PPI) and FIG. 3(b) (CPI). PPI resulted in a structure which was described as having very fine fibres which broke up easily, which is believed to contribute to extruded products based on pea protein as only additional vegetable protein, and oat derived composition, breaking up easier as compared to extruded products comprising chickpea protein. CPI (FIG. 3(b)) resulted in a structure which was described as rubber-like, not suitable as such for an extruded food product, but believed to contribute to obtained desirable properties and suitability for extrusion when mixed with the oat derived composition. Further, the results are believed to explain that relatively high amounts of oat derived material, as compared to no chickpea protein present, may be mixed in with the extrusion mixture comprising chickpea protein and still provide desirable texture.

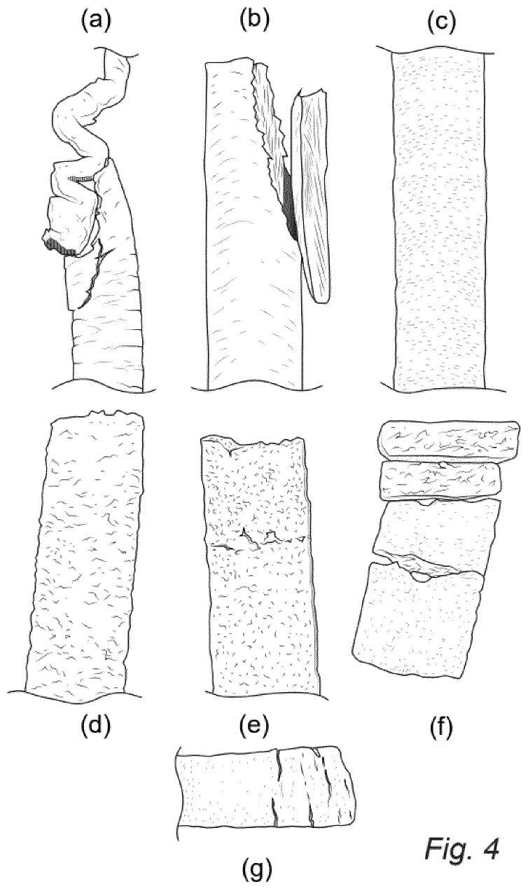

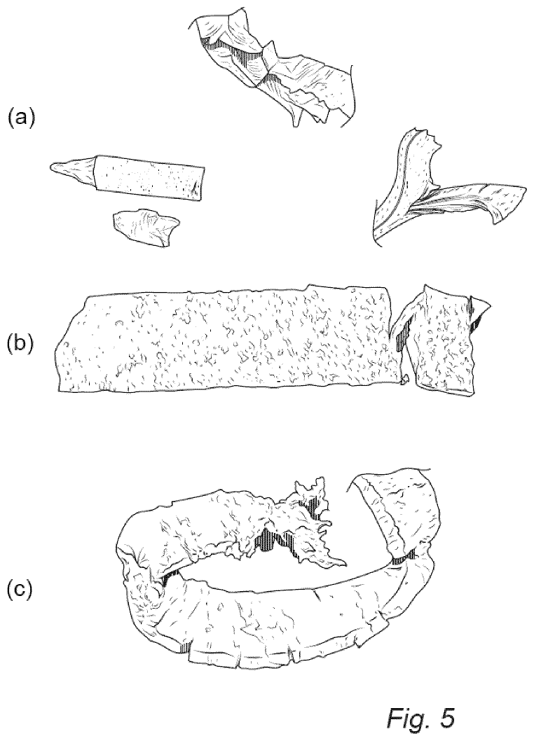

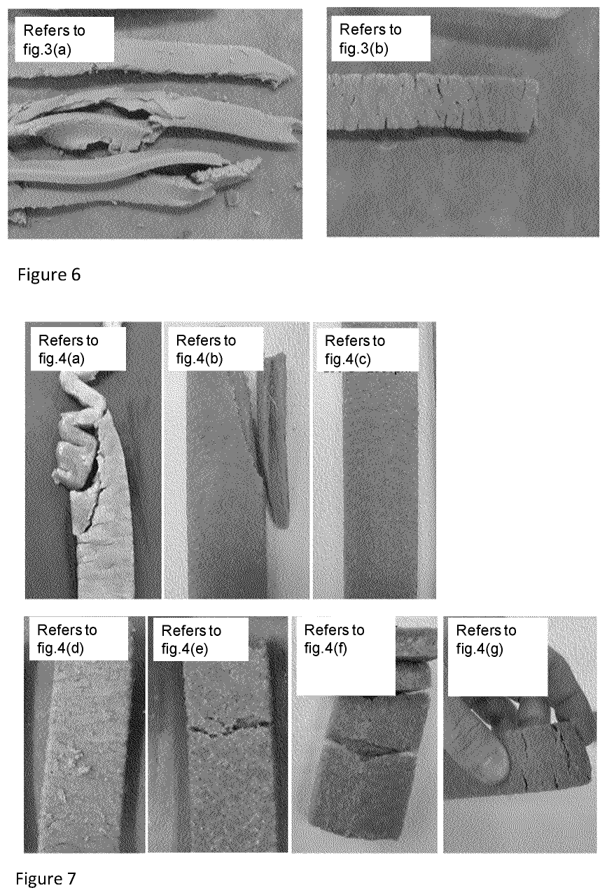

FIGS. 4(a) to (g) illustrate extruded products. CPI was used as only additional vegetable protein, combined with oat derived composition (ODC) and water, in the extrusion mixture and the illustrated products. FIG. 4(a) illustrates a comparing extruded product based on 100% CPI by dry weight of the extrusion mixture and 55% water by weight of the extrusion mixture, in the extrusion mixture, i.e. without a content of ODC, which extruded product was described as having a compact and rubber-like texture not desirable for an extruded meat substitute product.

FIG. 4(b) illustrates an extruded product based on 19% ODC, 81% CPI, by dry weight of the extrusion mixture, and 50% water by weight of the extrusion mixture. FIG. 4(c) illustrates an extruded product based on 28.5% ODC, 71.5% CPI, by dry weight of the extrusion mixture, and 50% water by weight of the extrusion mixture. FIG. 4(d) illustrates an extruded product based on 30% ODC, 70% CPI, by dry weight of the extrusion mixture, and 58% water, by weight of the extrusion mixture. Of the experiment, these three extrusion mixtures related to FIGS. 4(b-d) were determined to have most desirable texture with a suitable fibrous meat-like structure. With reference to FIGS. 4(e-g) it was concluded that as the content of ODC was increased to or above 35% by dry weight of the extrusion mixture, the extruded products became more crumbly and considered less suitable for use as meat analogue. FIG. 4(e) illustrates an extruded product based on 35% ODC, and 65% CPI, by dry weight of the extrusion mixture, and 50% water by weight of the extrusion mixture. FIG. 4(f) illustrates an extruded product based on 40% ODC, 60% CPI, by dry weight of the extrusion mixture, and 50% water by weight of the extrusion mixture. FIG. 4(g) illustrates an extruded product based on 50% ODC, 50% CPI, by dry weight of the extrusion mixture, and 50% water by weight of the extrusion mixture. It was found from those experiments that 19.3% and 28.5% per dry weight of the extrusion mixture of oat derived composition performed best among those experiments. It was concluded that, with a content of chickpea protein, eg. CPI, in the extrusion mixture, a content of oat derived composition of about 15-35%, or 19-30%, such as 28.5%, by dry weight of the extrusion mixture, results in desirable extrusion food products having properties including meat-like appearance.

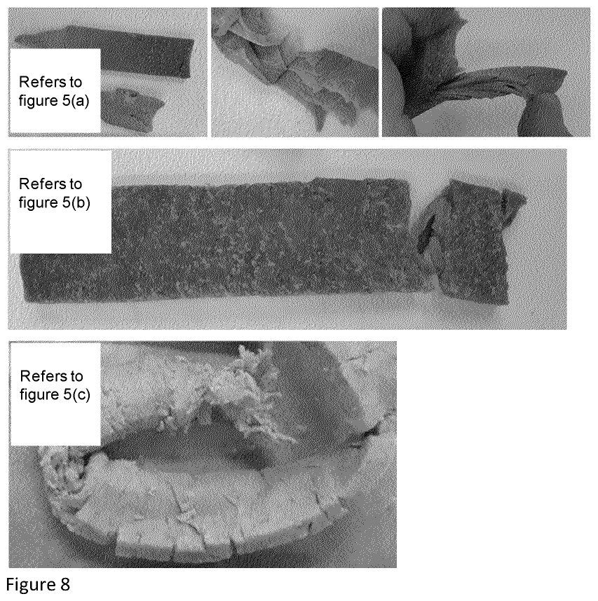

FIGS. 5(a) to (c) illustrate extruded products, intended as meat analogues, comprising different mixtures of CPI/OVPI/PPI and oat derived composition (ODC) as presented in table 3. In table 3, the amounts of additional vegetable protein and oat derived composition are given as dry weight of the extrusion mixture, while amounts of water is given as percent by weight of the wet extrusion mixture/extruded product. It was concluded that all extruded products illustrated in FIGS. 5(a) to (c) have properties desirable for meat analogue products, based on protein content but also for having a having fibrous structure. The structure and texture for the extruded product of FIG. 5(b), having the highest content of OVPI, had a relatively higher tendency, therefore less desirable, to form crumbs. Presence of PPI and/or CPI instead of OVPI reduced the crumbling tendency. In addition, it was shown that a mix of CPI and PPI present at ratio 1:1 resulted in a suitable meat-substitute product. It was further concluded from the experiments that desirable results were obtained with an extrusion mixture comprising, by dry weight of the mixture, above 20% or around 30%, such as 20-40%, or 30-40% of oat derived composition, and around 70%, such as 60-80%, or 60-70% additional vegetable protein fraction.

TABLE 3
Amounts of CPI/OVPI/PPI and ODC per dry weight of the
extrusion mixture, and water by weight of the wet extrusion
mixture/extruded product, for different extruded products
illustrated in FIGS. 5 (a) to (c).

Extruded product

| | CPI | OVPI | PPI | ODC | Water |
|---|---|---|---|---|---|
| FIG. | [%] | [%] | [%] | [%] | [%] |
| 5 (a) | 60 | 10 | 10 | 20 | 50 |
| 5 (b) | 60 | 15 | — | 25 | 50 |
| 5 (c) | 35 | — | 35 | 30 | 55 |

### Texture

Results from cutting resistance experiments of examples of extruded products are presented in table 4. All examples resulted in a ratio above 1 and higher than the comparative example, indicating a fibrous structure suitable for use as meat analogues or substitutes.

TABLE 4
Textures for different samples. “ODC” denotes
oat derived composition. Amounts of ODC/PPI/CPI per dry
weight of the extrusion mixture, and H₂O by weight
of the wet extrusion mixture/extruded product.

| | | Ratio |
|---|---|---|
| Sample | Comment | (accross/along) |
| Comparative | Chicken substitute (commercially | 1.09 |
| example 1 | available product). Based on Soy | |
| | protein (10%). | |
| Example 1 | 71% PPI + 29% ODC, 50% H₂O | 1.11 |
| Example 2 | 71% CPI + 29% ODC, 50% H₂O | 1.75 |
| Example 3 | 81% CPI + 19% ODC, 50% H₂O | 1.17 |
| Example 4 | 60% CPI + 40% ODC, 50% H₂O | 1.19 |

Use of CPI provides higher ratio as compared to corresponding use of PPI.

### Example—Extrusion and Cooking of Product

Another set of extrusion experiments were performed using a twin-screw extruder (laboratory co-rotating twin-screw KETSE 20/40D extruder, Brabender, Germany) with the purpose of producing samples for tasting sessions. Two recipes were chosen for sensory evaluation and listed in table 5. Temperature settings, at zones 1-5, for sample A were 40/80/130/150/133° C. and for sample B 40/80/120/140/126° C. The temperature out from the cooling nozzle was set at 25° C.

TABLE 5
Extrusion mixtures for double screw extruder. PPI/CPI and
oat derived composition per dry weight of the extrusion
mixture and water by weight of the extrusion mixture.

| | | | | Oat derived |
|---|---|---|---|---|
| | Water | PPI | CPI | composition |
| Sample | 65% | 35% | 35% | 30% |
| A | | | | |
| Sample | 65% | 0% | 60% | 40% |
| B | | | | |

Extruded samples were collected and teared in pieces and fried in a small amount of rape seed oil, followed by serving to a small tasting panel. It was concluded by the tasting panel that the fried extruded product appeared with a nice fried colour, and the taste experience was perceived well by the small tasting panel. The chewing resistance resembled meat to some extent and the taste was surprisingly neutral with only a mild pea-flavour.

Examples and embodiments have been discussed above with reference to FIGS. 2 to 5, which attempt to illustrate and convey characteristics of the extruded products using black-and-white drawings of photographs of samples of extruded products. As supplementary illustrations of the extruded products, photographs of the extruded products as drawn in FIGS. 3(a) and 3(b), 4(a) to (g), and 5(a) to (c) are illustrated in FIGS. 6, 7, and 8, respectively.

Further, the current invention have been discussed in relation to some examples, but however the invention is not limited to these examples since the skilled person would be aware of further examples within the scope of the claims.

1. A process for manufacturing of an extruded food product, comprising
extruding, under heating, of an extrusion mixture comprising:
an oat derived composition comprising oat protein and dietary fibre;
one or more additional vegetable protein fractions; and
water;
whereby an extruded food product is formed.

2. The process for manufacturing of an extruded food product according to claim 1, wherein the oat derived composition comprises, by dry weight of the composition, 20-55% of oat protein, and 20-40% of dietary fibre; and the one or more additional vegetable protein fractions is selected from the group consisting of pea protein fraction, and chickpea protein fraction.

3. The process for manufacturing of an extruded food product according to claim 1, further comprising
mixing of the oat derived composition and the one or more additional vegetable protein fractions before or during the extruding under heating, and
adding water.

4. The process according to claim 1, wherein the one or more additional vegetable protein fractions comprises chickpea protein.

5. The process according to claim 4, wherein the one or more additional vegetable protein fractions further comprises pea protein.

6. The process according to claim 1, wherein each of the one or more vegetable protein fractions independently is selected from vegetable protein fractions having a protein content of at least 95%, protein isolate having a protein content of at least 80%, or a protein concentrate having a protein content of at least 50%.

7. The process according to claim 1, wherein the oat derived composition further comprises, by dry weight of the composition, 5-20% of fat, and 3-20% of carbohydrates.

8. The process according to claim 1, wherein the extrusion mixture comprises, by dry weight of the extrusion mixture, 20-45% of the oat derived composition; and 55-80% of the one or more additional vegetable protein fractions.

9. The process according to claim 1, wherein the extruding is performed by a single screw extruder or a double screw extruder, wherein the heating involves increasing the temperature of the extrusion mixture within the temperature range 25 to 160° C.

10. An extruded food product obtainable by the process according to claim 1.

11. An extruded food product comprising an oat derived composition comprising oat protein and dietary fibre; one or more additional vegetable protein fractions; and water.

12. The extruded food product according to claim 11, wherein the oat derived composition comprises, by dry weight of the composition, 20-55% of oat protein, and 20-40% of dietary fibre; and the one or more additional vegetable protein fractions is selected from the group consisting of pea protein fraction, and chickpea protein fraction.

13. The extruded food product according to claim 11, wherein the one or more additional vegetable protein fractions comprises chickpea protein.

14. The extruded food product according to claim 13, wherein the one or more additional vegetable protein fractions further comprises pea protein.

15. The extruded food product according to claim 11, wherein each of the one or more vegetable protein fractions independently is selected from vegetable protein fractions having a protein content of at least 95%, protein isolate having a protein content of at least 80%, or a protein concentrate having a protein content of at least 50%.

16. The extruded food product according to claim 11 wherein the oat derived composition further comprises, by dry weight of the composition, 5-20% of fat, and 3-20% of carbohydrates.

17. The extruded food product according to claim 11 comprising, by dry weight of the extruded food product, 20-45% of the oat derived composition; and 55-80% of the one or more additional vegetable protein fractions.
